(19) United States
(12) Patent Application Publication
(10) Pub. No.: US 2007/0226125 A1
(43) Pub. Date: Sep. 27, 2007

(54) INTERACTIVE SYSTEM AND METHOD FOR TRANSACTING BUSINESS

(76) Inventors: John D. Temte, Boulder, CO (US); Timothy Newcomb, Laramie, WY (US); Matt S. Etlinger, Boulder, CO (US)

Correspondence Address: LATHROP & GAGE LC, 4845 PEARL EAST CIRCLE, SUITE 300, BOULDER, CO, 80301, US

(21) Appl. No.: 11/684,155

(22) Filed: Mar. 9, 2007

Related U.S. Application Data
(60) Provisional application No. 60/781,212, filed on Mar. 10, 2006.

(51) Int. Cl. G06Q 40/00

(52) U.S. Cl. 705/37

(57) ABSTRACT

A system is disclosed allowing potential buyers of products or services to collectively bargain with potential sellers. Potential buyers of the same product or service are organized into a buyers' group through a user interface. Potential sellers may bid against one another to win the business of individual buyers' group, potentially driving the final price lower than the price initially set by the buyers' group.

### RELATED APPLICATIONS

This application claims benefit of priority to U.S. Provisional Patent Application Ser. No. 60/781,212 filed Mar. 10, 2006.

### FIELD OF THE INVENTION

The present invention relates to a system for transacting business over a network. More particularly, the system allows multiple users to organize and collectively bargain with potential sellers or service providers.

### BACKGROUND

Companies and individuals utilize various methods to transact business over the Internet. Most online shopping resembles traditional shopping experience with the exception that the goods are shown to potential buyers over the Internet and are delivered by carriers after the transaction is finalized.

Other methods of Internet business transaction include online auctions and the likes held by eBay or Priceline. The eBay business method allows individual sellers to post an item for sale on eBay's website along with a starting bidding price. The seller may also specify the time when the auction is to end. Potential buyers can log on to the eBay website and bid for the item. The bidder who holds the highest bid at the end of the auction is entitled to purchase the item at the final bidding price.

The Priceline model differs from the eBay method in that it is typically initiated by a potential buyer. Under the Priceline method, for example, a potential buyer of a flight ticket may log on to Priceline.com and name the departure and destination cities, date of flight and the price the buyer is willing to pay. If the price requested by the potential buyer is accepted by registered sellers of Priceline, which are typically travel agencies and airlines, the transaction is completed. If the price requested by the potential buyer is never accepted by any sellers, the buyer may choose to increase the price or modify the terms of the offer.

Although these various methods allow buyers and sellers to interact in a auction and auction-like environment before completing a business transaction, none of them facilitate collective bargaining power among a related group of buyers, such as affording buyers with similar needs an opportunity to collectively bargain with potential sellers in order to obtain a group discounts. It is desirable to provide online shoppers with a mechanism to bargain collectively for lower prices or other advantages. From the seller's perspective, there is a need for a more efficient way to deal with a group of potential buyers such that larger volume of sale may be achieved with minimal transactional cost.

### SUMMARY

The system and method reported herein permit potential buyers to associate as a group for collective bargaining with potential sellers. More particularly, the disclosed method enables an individual consumer or ‘eSwarmer’ to start a group that is referred to herein as a ‘Swarm.’ The Swarm targets a product or service, together with other transaction al details. These details usually include what price the individual consumer is willing to pay for that product or service, together with a ‘Swarm Duration’ of how long the consumer will wait for a seller to sell the product/service at the designated price.

In starting a Swarm, a consumer seeks to attract to his or her Swarm as many like-minded consumers as possible to grow the Swarm. By aggregating their separate purchases into a single aggregated value as a ‘buying Swarm,’ these consumers entice potential sellers or ‘Swarm-Suppliers’ to sell at that designated price. The growth of a Swarm may eventually lead to the creation of a reverse auction or ‘Bid Battle’ in which Swarm-Suppliers competitively bid against one another for the Swarm's business, potentially driving the price-to-be-paid lower than the designated price set by the eSwarmer who began the Swarm.

The disclosed instrumentalities also enable individual consumers to impose “other” conditions for their purchases, in order to motivate consumers who also self-identify as members of a group to strengthen their group by requiring that Swarm-Suppliers reflect their group's dynamics. For example, union-member driven buying Swarms will be able to impose “must be union-organized” as a condition to the sale to a union-member Swarm. Other conditions may be imposed in like manner, such as restricting sellers to a religious affiliation, hobby, sporting interest, endorsement, ethnicity, or a political affiliation or imposing as a condition of any sale that the supplier makes a percentage donation to a particular organization, such as a church, NGO (non-governmental organization).

By way of example, a pro-union consumer may search for Swarms that have an AFL-CIO affiliation, or unions in general, or to search for Swarms which have as a restriction “must be union-organized.” In another example, a liberal blog reader may search for Swarms begun by the owner of Daily Kos. A conservative blog reader may search for Swarms begun by Matt Drudge who owns the Drudge Report. A member of The Church of Jesus Christ of Latter-Day Saints may search for Swarms begun by other church members. A Jewish person may search for Swarms associated with kosher foods. A Muslim may search for halal foods, as well as shari'a compliant products or investment opportunities. An environmentalist may search for Swarms that are linked to an ideal, such as Swarms that are associated with a category of ‘green’ organizations with an environmentally friendly purpose.

This ability to impose search conditions that affiliate the Swarm with an organization or concept may also permit the Swarm rules to specify that the Swarm will provide a monetary benefit to the organization or concept. In one example, a portion or percentage of the sale proceeds may be earmarked for this purpose. In another example, an eSwarmer may voluntarily specify a quantity of money to the organization or concept as a gift. This may be done, for example, by establishing a Swarm rule that one percent or five percent of the sale proceeds will benefit a particular school or group of schools.

The Swarm rules may also specify other conditions. For example, the buyers may be permitted to evaluate other conditions in addition to price, and vote or otherwise elect to purchase the product or service from the seller whose price and quality of product or service are overall deemed best by the group. Thus, a group may decide not to purchase on the basis of low price alone, but may consider warranty, reputation, or other factors when making a decision to purchase. Alternatively, the rules of the Swarm may require the purchasing decision to be made solely on the basis of low price. The rule may permit the Swarm to identify itself as having an affiliation or endorsement with another entity, such as a school, church, political party, or non-governmental organization, and to direct at least a portion of the transaction funds to the entity as a monetary benefit of the transaction.

In allowing a Swarm to impose these other conditions, i.e., conditions beyond the economics of rapidly formed and executed group-purchases, the method may increase and enhance the strength of ‘Bonded Communities’ that share a commonality with respect to the other conditions. Members of a Swarm may be bonded through these “other” conditions because they may all identify themselves as, for examples, members of a union, or skiers.

In addition, the system and method disclosed herein allow small Swarm-Suppliers to form ‘Selling Swarms,’ in order to compete for a Swarm's business, thereby enabling small sellers to compete effectively against larger sellers examples, members of a union, or skiers.

### BRIEF DESCRIPTION OF THE DRAWINGS

FIG. 1 is a buyer-side process diagram that shows a method of operation for an electronic system according to the instrumentalities described herein for facilitating a transaction;

FIG. 2 provides additional detail with respect to the process of FIG. 1; and

FIG. 3 is a supplier-side process diagram that shows a method of operation for an electronic system according to the instrumentalities described herein for facilitating a transaction;

### DETAILED DESCRIPTION

Before the system and method are illustrated in greater detail, some terms used in this disclosure are defined for purpose of clarification.

In a systems context, “eSwarm” means a platform using an Internet website for consumers to join together with others for their own economic advantage. eSwarm also provides a platform for suppliers to supply products or services to those consumers.

An “eSwarm”, also known as a “Swarm,” refers to a group of eSwarmers who have joined together to purchase a particular product or service, either for purely economic reasons or to strengthen their group's economic power. An eSwarm is made up of like-minded consumers who have aggregated their separate purchases into a single and larger buying-Swarm in order to entice sellers, i.e., Swarm-Suppliers, to sell a designated product/service at the price designated when the Swarm was started.”

“Swarm Duration” means the time frame designated by the individual user who starts a Swarm specifying the expiration time of a Swarm. If no deals have been reached at the expiration time, a Swarm will dissolve and ceases to exist. Any bids submitted to a Swarm after the Swarm expiration time are void.

The term “Designated Price” means the highest price under which a product or service will be accepted by a Swarm. The “Designated Price” is specified by the user who initially set up a Swarm.

An “eSwarmer” refers to an individual consumer or entity that starts a Swarm or joins a Swarm. As such, the eSwarmer is a member of a community of interest including like-minded persons who have an interest in bringing together a group of persons as a Swarm, or in being a Swarm participant. An eSwarmer is often a consumer, but sellers are not excluded from this definition unless specifically noted.

“Swarm-Supplier” means a supplier of the product/service sought by an eSwarm (or Swarm), typically a manufacturer, retailer, service provider, etc.

The term “eSwarmed” refers to a stage in the process when a product or a service has been “Swarmed,” i.e., like-minded consumers have formed a group to entice a Swarm-Supplier to supply a Swarm.

“eSwarmable” means any product or service that may be eSwarmed.

“eSwarming” refers to the act of like-minded consumers joining together to aggregate their separate purchases into a single and larger buying-Swarm in order to entice sellers (Swarm-Suppliers) to sell a designated product/service at the price designated when the Swarm was started.

The phrase “Search for existing Swarms” refers to the initial searching of eSwarm's website for: (a) particular product/service (b) Swarms started by a particular person, group or entity (c) particular restrictions on suppliers and/or (d) coupon/rebate Swarms that are being Swarmed.

The term “Join Swarm” means the act of joining an existing Swarm for price designated and under the terms designated when the Swarm was started, when you join a Swarm you are obligated to buy under the terms and conditions given.

The phrase “Start Your Own Swarm!” refers to the act of starting a Swarm for a particular product or service. When a person starts or joins a Swarm, the person at that point becomes obligated to buy if the Swarm conditions are met.

The phrase “View all Swarms” means the act of reviewing all Swarms on eSwarm's operating platform.

The term “My eSwarm” refers to a private place on eSwarm for each eSwarmer that lists Swarms started, Swarms joined and Swarms being monitored. Each Swarm's status regarding bid status, current price, members (Swarmers), payment, bid and time to close is also listed. The “My eSwarm” page allows group members to communicate with one another and to be informed about other Swarms started by their group. 33 The phrase “Supply This Swarm” refers to the act of submitting a bid to supply a Swarm and certifying that all conditions imposed on the Swarm will be met.

“eSwarm Challenge!” is a list of products/services which eSwarm is challenging eSwarmers to Swarm.

In an exemplary embodiment, an eSwarmer who wishes to purchase a Jeep Grand Cherokee may visit a website, log in with a User Name and password, and instantly start a Jeep Grand Cherokee Swarm by:
(1) designating how much he/she was willing to pay for the Grand Cherokee,
(2) designating how long he/she was willing to wait for a supplier to bid on his/her Jeep Grand Cherokee Swarm, and (3) emailing and calling friends and communicating through group bulletin boards, etc, to join his/her Jeep Grand Cherokee Swarm. By combining separate purchases into an aggregate “Swarm,” Swarmers attempt to entice suppliers to bid on their Swarm's business at the designated prices.

When a Jeep dealer bids to sell a Jeep Grand Cherokee to the Swarm at the designated price and agrees to any additional conditions (such as making a percentage donation to an organization or religion), the size of that Swarm immediately freezes and the potential for a reverse auction (Bid Battle) is created where other dealers could bid against one another as they compete for that Swarm's business. The dealer offering the lowest bid price at the end of a Swarm's duration becomes the prevailing Swarm-Supplier. At that point, both the dealer and eSwarmers are obligated to complete their agreements, the dealer to sell to each Swarmer a Grand Cherokee at the designated price and eSwarmers to buy at the designated price

Using the same Jeep Grand Cherokee example, if an eSwarmer belongs to a group, such as a union, and wants to strengthen the power of that group, the eSwarmer may impose other condition to the Swarm. For example, an eSwarmer may place the limitation that the Swarm-Supplier “must be union-organized.” In that case, a potential seller has to certify to eSwarm that it meets all the conditions, including being a union-organized employer before it can bid on that particular Swarm.

An eSwarmer who wishes to obtain better credit card debt interest rates, more affordable health insurance and cheaper stock-transaction fees, could come to eSwarm and instantly start three such Swarms by: (1) designating how much he/she was willing to pay for each service, (2) designating how long he/she was willing to wait for a supplier to bid on his/her Swarms, and (3) emailing and calling friends and communicating through “group bulletin boards” on eSwarm, etc, to join his/her credit card debt interest rate Swarm, health insurance Swarm and stock-transaction fee Swarm. By combining separate purchases into an aggregate “Swarm,” Swarmers are attempting to entice suppliers to bid on their Swarms at the designated prices.

If a health insurance company, credit card company or stock trading company bids to supply any Swarm, the size of that Swarm instantly freezes and the potential for a reverse auction (Bid Battle) is created, where suppliers can bid against one another as they compete for a Swarm's business. The Swarm-supplier with the lowest bid price at the end of a Swarm's duration becomes the prevailing supplier. At that point, both the supplier and Swarmers are obligated to complete the transaction. In other words, the supplier is obligated to sell at the final bidding price and all Swarmers in the Swarm are obligated to buy at the final bidding price.

In addition, using the credit card debt interest rates, health insurance and stock-transaction fee example above, if the eSwarmer belongs to a group, such as a union, and wants to strengthen the power of that group, the eSwarmer may impose such other condition as that the Swarm-Supplier “must be union-organized.” Under that circumstance, a credit card company, a health insurance company or a stock-trading company has to certify to eSwarm that it meets all the conditions, including, in this case, that the company is union-organized, before it can bid on those particular Swarms.

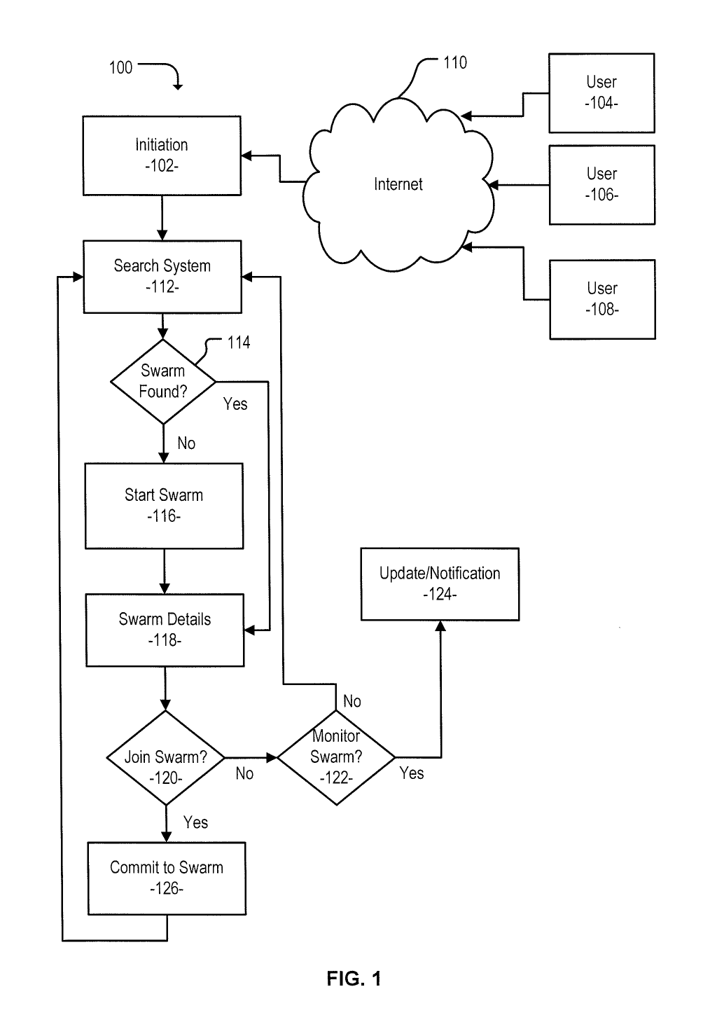

FIG. 1 is a process flow diagram according to one embodiment. The process 100 may be implemented as a system through a combination of program instructions, circuitry, and data storage.

A consumer initiates a session in Step 102: One or more individual consumers, shown in FIG. 1 as users 104, 106, 108, may visit the system through use of the Internet 110, or by patching in from a linked site to any system product or service page. Eventually, each user creates an account with the system. A user may complete the registration process at any point prior to actually joining a Swarm. Users may be individuals or entities, such as corporations. Registration entails the user providing the system with sufficient information to identify the user as an eSwarmer, together with appropriate billing information. Once registered, users initiate sessions by logging onto the system.

A user or eSwarmer searches the system in Step 112. The particular search mechanism is not particularly important, since a variety of generic search reporting mechanisms are known in the art and may be readily adapted for the purposes described herein. Users may use keyword searching to provide a list of Swarms that contain text matching the keywords. Alternatively, users may access pre-reported Swarms that are reported by category of merchandise or service, remaining Swarm duration, or other Boolean search criteria. Users may use a wide variety of website navigation techniques to arrive at any product or service page on the system website. For example, users may select the desired product or service Swarm or Swarms by clicking on a hyperlink to navigate to a designated Swarm.

After the optional searching step 112, a user may decide that there is not a suitable Swarm in existence. Thus, Step 114 permits a user to start a Swarm in Step 116. In one example of this, the user starts a Swarm because he cannot find what he is looking for through a search in Step 112. In another example, the user proceeds to start his own Swarm without searching 112.

With the user having selected or started a Swarm, Step 118 entails providing the user with detailed information about the Swarm. The system informs the user about the product or service. For example, this action may entail providing a multimedia description of the particular product or service, as well as information about the Swarm. The Swarm information may include any information that is necessary to implement a scheme of collective bargaining, such as the number of individual purchases that are required to take advantage of a mass purchase and to obtain a bulk purchase price, rate, or discount on the particular product or service.

In Step 120, the user decides whether to participate in a Swarm, based upon the information received in Step 118. Accordingly, if the user desires to participate, the system prompts the user to enter information that facilitates the Swarm transaction, such as the quantity of the product that is desired, and confirmation that the user desires to join the Swarm. At this stage, a user may decide to monitor the Swarm, rather than join one. In one example, the user may be promoted to click a field caption “Watch This Swarm” 122, whereupon the system may provide periodic notices and updates 124. If the consumer does not want the particular product or service he or she may return to step 112 to search for a new product or service as before, or to and start a new Swarm that designates any price, duration or other condition. If in Step 120 the user decides to participate in a Swarm, Step 126 entails an exchange of information as needed to facilitate the transaction. The user may be routed back to search system 112, or my choose to terminate the session at any time.

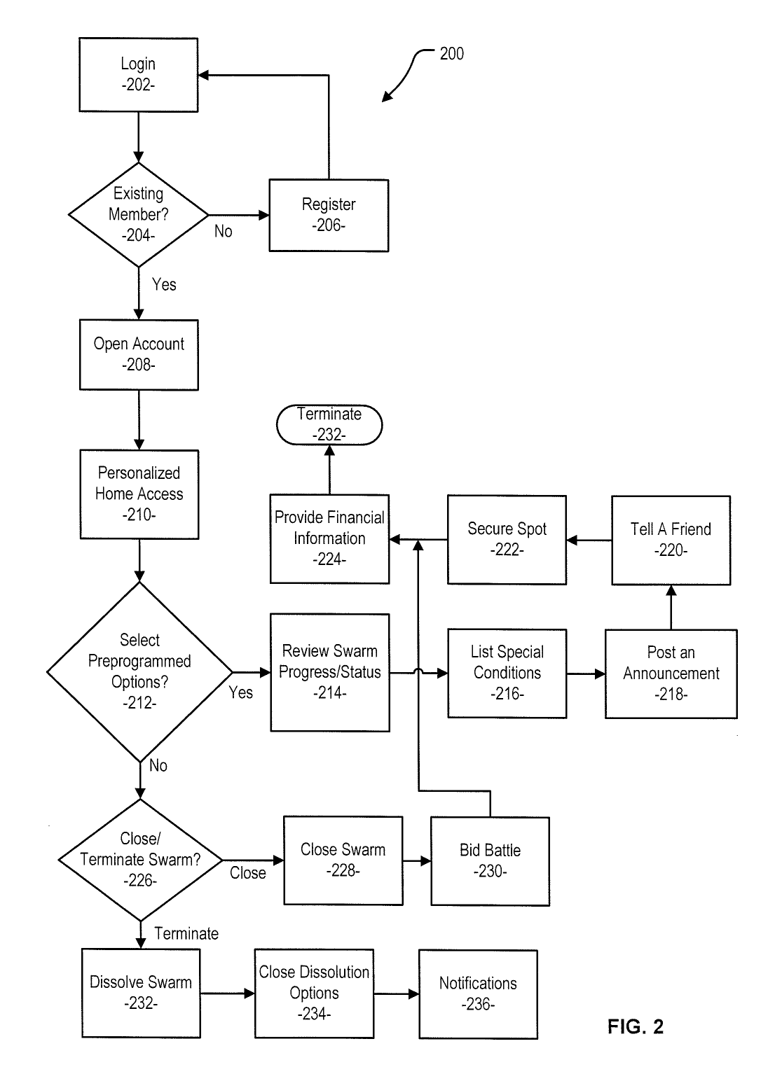

FIG. 2 is a flow diagram of a login/registration process 200 that may precede any of Steps 102,116,122, and/or 126 of FIG. 1. The user is routed to a login function 202, which asks sufficient information to assess whether the user is an existing member of a non-member. In Step 204, nonmembers are routed to registration function 206 to create an account with an exchange of useful information to that end. Existing members may open their account 208 by providing a password, biometric data, host-terminal handshake or other form of identity confirmation.

After log-on, the user has personal access 210 to a personalized home page within the overall system. In one example, this may be a “my eSwarm page” where a listing of the eSwarm/Swarms he or she has signed up for are located for monitoring 214. For example, a “My eSwarm” option may display the Swarm or Swarms the eSwarmer has started, joined, or is monitoring, as explained above. Several other options may appear including but not limited to a “description” 216 of current Swarms or a listing 218 of “special conditions,” “post an announcement” 220 and “tell a friend about this Swarm” 220, among others.

If the user is monitoring a Swarm (see Steps 122,124 of FIG. 1), the user may be provided with an option 222 to secure a place in the Swarm. The user is routed to the transaction page where he may enter payment information that the system needs to complete the transaction. Whenever the user decides to start or join an eSwarm or Swarms, he or she is prompted to enter appropriate financial information.

Step 226 tests whether Swarm-Supplier has bid to supply a Swarm under all designated terms. If so, the Swarm is closed 228 and no more new members can join in. If a bid battle 230 ensues, the lowest bid “wins” and the Swarm-Supplier that supplied the bid is the prevailing Swarm-Supplier. At that point, eSwarmer transfers or confirms the appropriate financial information independently of eSwarm to the Swarm-Supplier to obtain payment under the agreements of the Swarm.

In Step 226, if no Swarm-Supplier bids on a Swarm with all of the requirements and conditions having been met, the Swarm dissolves 232 when the duration period ends. If the Swarm fails to meet the designated goals that are required to obtain the bulk purchase price, rate, or discount, all eSwarmers who have joined that particular Swarm may opt out 234 of the Swarm; or alternatively, the eSwarmer may be allowed to remain a part of the Swarm and to modify the designated time period and/or the designated price, rate, or discount.

The system provides notifications 236 to eSwarmers who will then be notified as to how to receive their product. This may be done by email through use of registration information, and through their personal home page on the system. Similarly, the participants are notified when the transaction actually happens. An additional emails may be sent to their My eSwarm account and their personal email concerning other details of the transaction as well such as how to receive the product or service.

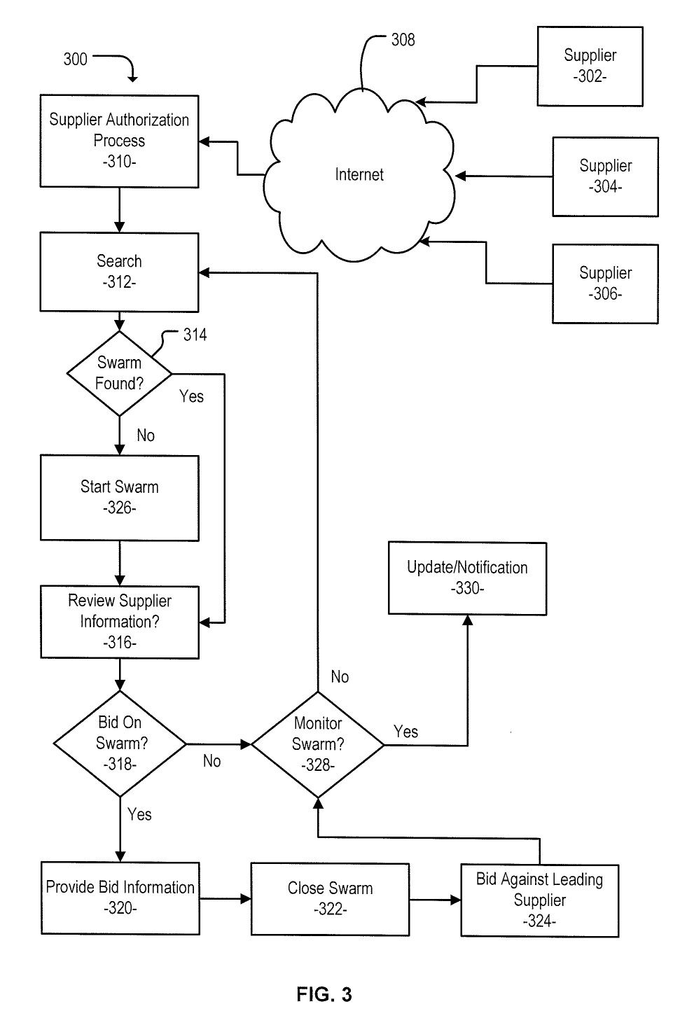

FIG. 3 is a flow diagram showing a process 300 for a Swarm Supplier on the system.

An individual supplier 302, 304, 306 may visit the system through use of the Internet 308. Fro the system home page, the supplier may link to a supplier authorization process 310. The supplier provides the system with such contact information, financial information, company information and other information as is needed to complete a Swarm transaction from the supplier side.

The supplier may then search 312 to find 314 any Swarm they want to bid to supply. In one example, this may be done by use of searching 312 to arrive at the page for a Swarm, clicking a supplier link, and commencing a password protected login. This permits the supplier to review supplier information 316, which may be followed by a decision to bid to supply the Swarm 318. If the supplier makes a decision to bid, he or she will be asked to provide bid information 320. This may entail providing the best price for various levels of demand that the supplier has the ability to supply., and/or other responses that are appropriate according to the rules of the transaction.

The Swarm will eventually close 322, after which other suppliers may optionally be permitted to bid against the leading supplier 324.

If the Supplier does not find a suitable Swarm in Step 314, the supplier may also start a Swarm 326. If the supplier decides not to bid on the Swarm, the supplier may be asked whether to monitor the Swarm 328, in which case the System may provide periodic updates and notifications 330.

Those skilled in the art appreciate that the foregoing instrumentalities teach by way of example, and not by limitation. Accordingly, the what is claimed as the invention also encompasses insubstantial changes with respect to what is claimed. The inventor hereby states his intention to rely upon the Doctrine of Equivalents to protect the scope and spirit of the invention.

We claim:

1. A method for transacting business comprising:
(a) allowing an individual to start a group for the purpose of purchasing a product or a service;
(b) the individual designating a price at which the individual is willing to pay for that product or service;
(c) the individual designating a duration time during which the individual will wait for a seller to offer to sell the product or service at the price designated by the individual;
(d) allowing other individuals to join the group;
(e) allowing potential sellers to offer product or service to the group by bidding against other sellers; and
(f) completing a sale as one or more transactions between the group and a seller.

2. The method of claim 1 further comprising a step wherein the group is allowed to purchase the product or service from the seller whose price and quality of product or service are deemed best by the group.

3. The method of claim 1 further comprising a step wherein the group is only allowed to purchase the product or service from the seller whose price is the lowest offered by all the potential sellers.

4. The method of claim 1, further comprising a step:
(g) searching for products or services from among a plurality of groups, wherein the step (g) of searching entails a search of buying-Swarms that are associated with a particular condition other than a product or service.

5. The method of claim 4, wherein the particular condition is an association with a group or organization.

6. A system for transacting business comprising:
(a) means for allowing an individual to start a group for the purpose of purchasing a product or a service, for the individual to designate a price at which the individual is willing to pay for that product or service, and for the individual to designate a duration time during which the individual will wait for a seller to offer to sell the product or service at the price designated by the individual;
(b) means for allowing other individuals to join the group;
(c) means for allowing potential sellers to offer product or service to the group by bidding against other sellers; and
(d) means for completing a sale as one or more transactions between the group and a seller.

7. The system of claim 6, further comprising means for permitting the group to purchase the product or service from the seller whose price and quality of product or service are deemed best by the group.

8. The system of claim 1, further comprising means for searching for products or services from among a plurality of groups, wherein the means for searching permits a search of buying Swarms that are associated with a particular condition other than a product or service.

9. The system of claim 8, wherein the particular condition is an association with a group or organization.

10. The system of claim 9, further including means for providing a monetary benefit to the group or organization as a condition of the business transaction.
